(19) United States
(12) Patent Application Publication
(10) Pub. No.: US 2007/0189467 A1
(43) Pub. Date: Aug. 16, 2007

(54) Method and apparatus for bypassing overload control for emergency calls

(76) Inventors: Marian Croak, Fair Haven, NJ (US); Hossein Eslambolchi, Los Altos Hills, CA (US)

Correspondence Address: AT&T CORP., ROOM 2A207, ONE AT&T WAY, BEDMINSTER, NJ, 07921, US

(21) Appl. No.: 11/344,635

(22) Filed: Jan. 31, 2006

(51) Int. Cl. H04M 11/04

(52) U.S. Cl. 379/37

(57) ABSTRACT

A method and apparatus for enabling a network element to continue to process and respond to emergency, e.g., E911, call signaling messages despite any overload control mechanism that might be in effect due to congestions caused and experienced by other non-emergency call signaling messages are disclosed.

The present invention relates generally to communication networks and, more particularly, to a method and apparatus for bypassing overload control for emergency calls, e.g., E911 calls, in communication networks, e.g. packet networks such as Voice over Internet Protocol (VoIP) networks.

### BACKGROUND OF THE INVENTION

VoIP network providers are required to provide Enhanced 911 (E911) services that are equivalent in reliability and performance to the Public Switched Telephone Network (PSTN) counterpart. Failure to complete call setup of these emergency calls due to a network condition can have serious or even fatal consequences. When VoIP network elements enable overload control mechanism, these network elements typically do so on a per network element basis. If E911 call signaling messages are processed using the overload control mechanism, such as call gapping, some of the E911 call signaling messages can be unnecessarily delayed or blocked with serious consequences.

Therefore, a need exists for a method and apparatus for bypassing overload control for emergency calls, e.g., E911 calls, in a packet network, e.g., a VoIP network.

### SUMMARY OF THE INVENTION

In one embodiment, the present invention provides a method for a network element to continue to process and respond to emergency, e.g., E911, call signaling messages despite any overload control mechanism that might be in effect due to congestions caused and experienced by other non-emergency call signaling messages. For example, in order to eliminate the impact of the overload control on the E911 call, the E911 call is exempted from the overload control mechanism all altogether.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates an example of bypassing overload control for emergency calls, e.g., E911 calls, in a VoIP network of the present invention;

FIG. 3 illustrates a flowchart of a method for bypassing overload control for emergency calls, e.g., E911 calls, in a packet network, e.g., a VoIP network, of the present invention; and

FIG. 4 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

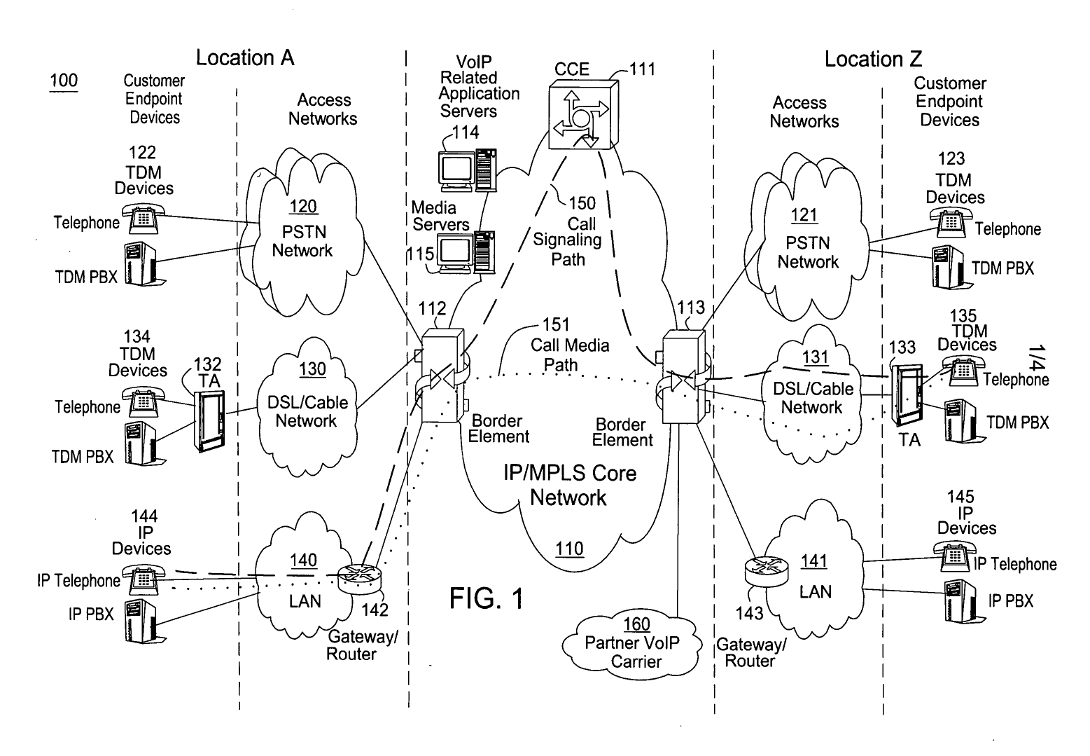

To better understand the present invention, FIG. 1 illustrates a communication architecture 100 having an example network, e.g., a packet network such as a VoIP network related to the present invention. Exemplary packet networks include internet protocol (IP) networks, asynchronous transfer mode (ATM) networks, frame-relay networks, and the like. An IP network is broadly defined as a network that uses Internet Protocol to exchange data packets. Thus, a VoIP network or a SoIP (Service over Internet Protocol) network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted to be limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related application server 114 to obtain the information to complete this call. In one embodiment, the Application Server (AS) functions as a SIP back-to-back user agent. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP 200 OK response message if SIP is used, is sent in the reverse direction back to the CCE 111. After the CCE 111 receives the call acknowledgement message, it will then send a call acknowledgement signaling message, such as a SIP 200 OK response message if SIP is used, toward the calling party. In addition, the CCE 111 also provides the necessary information of the call to both BE 112 and BE 113 so that the call data exchange can proceed directly between BE 112 and BE 113. The call signaling path 150 and the call media path 151 are illustratively shown in FIG. 1. Note that the call signaling path and the call media path are different because once a call has been setup up between two endpoints, the CCE 111 does not need to be in the data path for actual direct data exchange.

Media Servers (MS) 115 are special servers that typically handle and terminate media streams, and to provide services such as announcements, teleconference bridges, transcoding, and Interactive Voice Response (IVR) messages for VoIP service applications.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

VoIP network providers are required to provide Enhanced 911 (E911) services that are equivalent in reliability and performance to the Public Switched Telephone Network (PSTN) counterpart. Failure to complete call setup of these emergency calls due to a network condition can have serious or even fatal consequences. When VoIP network elements enable overload control mechanism, these network elements typically do so on a per network element basis. If E911 call signaling messages are processed using the overload control mechanism, such as call gapping, some of the E911 call signaling messages can be unnecessarily delayed or blocked with serious consequences.

To address this need, the present invention provides a method for a network element to continue to process and respond to emergency, e.g., E911, call signaling messages despite any overload control mechanism that might be in effect due to congestions caused and experienced by other non-emergency call signaling messages.

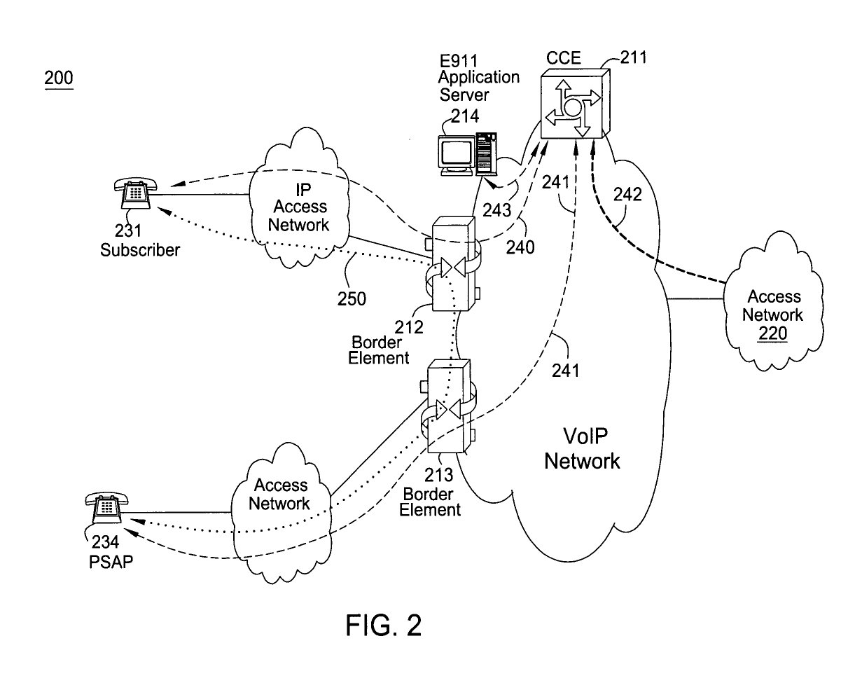

FIG. 2 illustrates an example 200 of bypassing overload control for emergency calls, e.g., E911 calls, in a packet network, e.g., a VoIP network of the present invention. In FIG. 2, a mass calling event originating from access network 220 is in progress. CCE 211 is experiencing extremely heavy call volume due to the mass calling event and has, therefore, enabled overload control mechanism to relieve congestions. For instance, CCE 211 has begun call gapping by dropping one out of three calls to relieve overload conditions and increased the signaling message queue length to accommodate more calls to be placed into the signaling message queue to minimize the impact of timeout on received signaling messages.

Subscriber 231 sends an E911 call setup message to CCE 211 via BE 212 using flow 240. Upon receiving the E911 call setup message, CCE 211 finds out that the call is an E911 call and has been performing overload control on all non-E911 calls. In order to eliminate the impact of the overload control on the E911 call, CCE 211 exempts the E911 call from the overload control mechanism all altogether. For instance, the E911 call setup message does not have to wait in the already long signaling message queue for non-E911 call signaling messages and the E911 call setup message is not subject to the currently active call gapping measure. Then, CCE 211 identifies the appropriate PSAP, e.g., PSAP 234, in which the call is to be terminated. CCE 211 identifies PSAP 234 by communicating with E911 AS 214 using flow 243. In one embodiment, E911 AS 214 performs a lookup of the subscriber's service address using the subscriber's phone number and then uses the obtained service address to identify PSAP 234 to handle the E911 call for the service address. CCE 211 sends the E911 call setup message to PSAP 234 via BE 213 using flow 241 for call establishment. BE 213 successfully completes the call to PSAP 234. Once the call is successfully established, subscriber 231 and PSAP 234 communicate with each other using media flow 250.

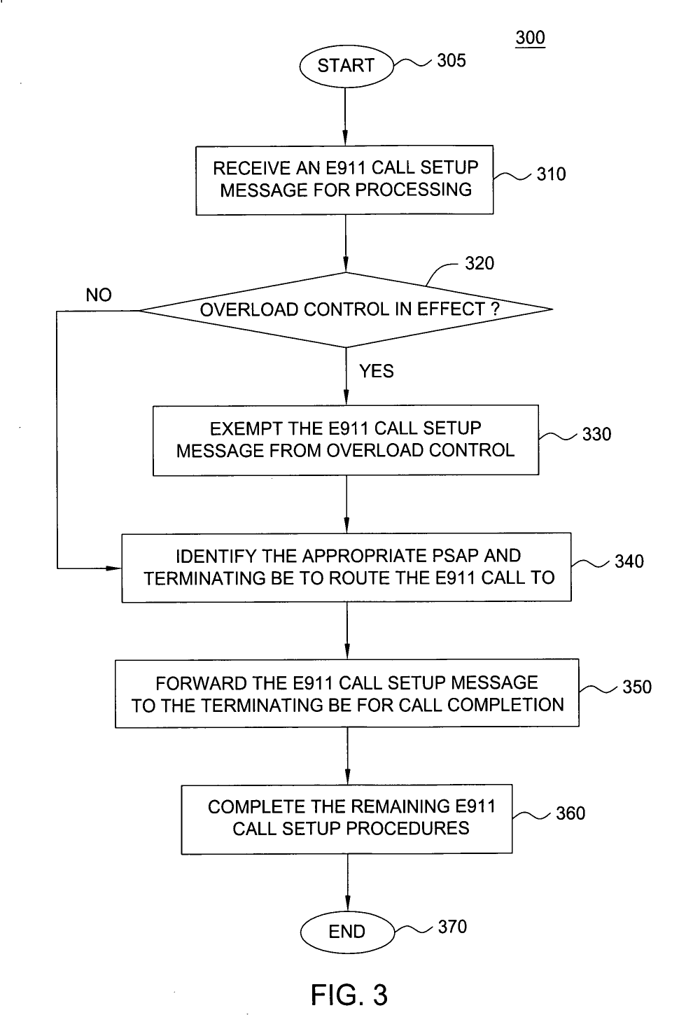

FIG. 3 illustrates a flowchart of a method 300 for bypassing overload control for emergency calls, e.g., E911 calls, in a packet network, e.g., a VoIP network, of the present invention. Method 300 can be executed by a CCE. Method 300 starts in step 305 and proceeds to step 310.

In step 310, the method receives an E911 call setup message. For example, the E911 call setup message is received by a CCE.

In step 320, the method checks if overload control of call signaling message processing is in effect. For example, the overload control status is checked by the CCE. If overload control of call signaling message processing is in effect, the method proceeds to step 330; otherwise, the method proceeds to step 340.

In step 330, the method exempts the E911 call setup message from any active overload control mechanisms, such as call gapping or queueing in lengthened signaling message queue for non-E911 signaling messages. For example, the E911 call setup message is exempted by the CCE from any active overload control mechanisms.

In step 340, the method identifies the appropriate PSAP and the terminating BE for call completion. For example, the PSAP and the terminating BE are identified by the CCE. Specifically, the appropriate PSAP is identified by the CCE by communicating with an E911 AS. In one embodiment, the E911 AS performs a lookup of the subscriber's service address using the subscriber's phone number and then uses the obtained service address to identify the appropriate PSAP to handle the E911 call for the service address.

In step 350, the method forwards the E911 call setup message towards the identified PSAP via a terminating BE to complete the call. For example, the E911 call setup message is forwarded towards the identified PSAP by the CCE.

In step 360, the method completes successfully the E911 call to the identified PSAP. For example, the E911 call is completed by the CCE via the terminating BE. The method ends in step 370.

In another embodiment, step 330 can be executed by other network elements such as a BE or an AS as well. For instance, if a BE has enabled overload control due to heavy call signaling traffic, the BE will exempt an E911 call setup message from any active overload control mechanisms, such as call gapping or queueing in lengthened signaling message queue for non-E911 signaling messages.

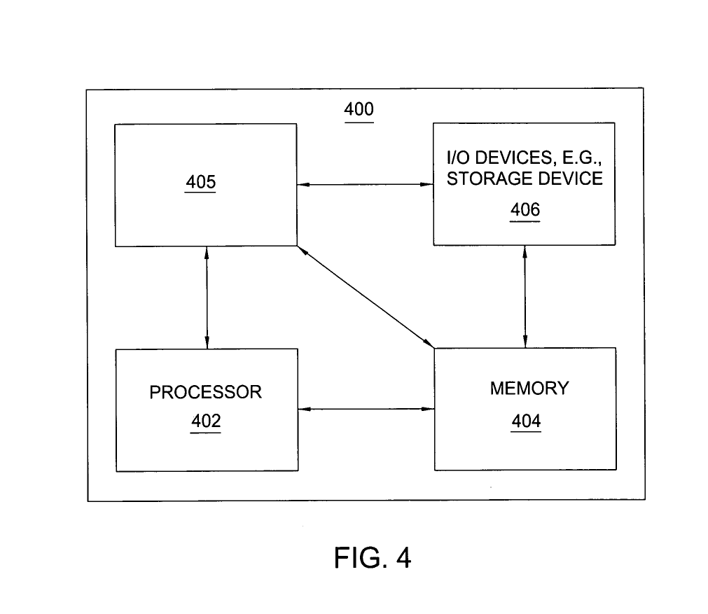

FIG. 4 depicts a high level block diagram of a general purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for bypassing overload control for emergency calls, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for bypassing overload control for emergency calls can be loaded into memory 404 and executed by processor 402 to implement the functions as discussed above. As such, the present process 405 for bypassing overload control for emergency calls (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for bypassing overload control in a communication network, comprising:
receiving an emergency call setup message for establishing an emergency call; and
exempting said emergency call setup message from an overload control mechanism that is applied to at least one non-emergency call signaling message if said overload control mechanism is enabled.

2. The method of claim 1, wherein said communication network is a Voice over Internet Protocol (VoIP) network or a Service over Internet Protocol (SoIP) network.

3. The method of claim 1, wherein said emergency call is an Enhanced 911 (E911) call.

4. The method of claim 1, wherein said emergency call setup message is received by a network element of said communication network.

5. The method of claim 4, wherein said network element comprises at least one of: a Call Control Element (CCE), a Border Element (BE), or an Application Server (AS).

6. The method of claim 1, wherein said overload control mechanism comprises at least one of: a call gapping mechanism or a signaling message queue lengthening mechanism.

7. The method of claim 6, wherein said exempting comprises:
excluding said emergency call setup message from said call gapping mechanism; or
advancing said emergency call setup message to a head of a lengthened signaling message queue.

8. A computer-readable medium having stored thereon a plurality of instructions, the plurality of instructions including instructions which, when executed by a processor, cause the processor to perform the steps of a method for bypassing overload control in a communication network, comprising:
receiving an emergency call setup message for establishing an emergency call; and
exempting said emergency call setup message from an overload control mechanism that is applied to at least one non-emergency call signaling message if said overload control mechanism is enabled.

9. The computer-readable medium of claim 8, wherein said communication network is a Voice over Internet Protocol (VoIP) network or a Service over Internet Protocol (SoIP) network.

10. The computer-readable medium of claim 8, wherein said emergency call is an Enhanced 911 (E911) call.

11. The computer-readable medium of claim 8, wherein said emergency call setup message is received by a network element of said communication network.

12. The computer-readable medium of claim 11, wherein said network element comprises at least one of: a Call Control Element (CCE), a Border Element (BE), or an Application Server (AS).

13. The computer-readable medium of claim 8, wherein said overload control mechanism comprises at least one of: a call gapping mechanism or a signaling message queue lengthening mechanism.

14. The computer-readable medium of claim 13, wherein said exempting comprises:
excluding said emergency call setup message from said call gapping mechanism; or
advancing said emergency call setup message to a head of a lengthened signaling message queue.

15. An apparatus for bypassing overload control in a communication network, comprising:
means for receiving an emergency call setup message for establishing an emergency call; and
means for exempting said emergency call setup message from an overload control mechanism that is applied to at least one non-emergency call signaling message if said overload control mechanism is enabled.

16. The apparatus of claim 15, wherein said communication network is a Voice over Internet Protocol (VoIP) network or a Service over Internet Protocol (SoIP) network.

17. The apparatus of claim 15, wherein said emergency call is an Enhanced 911 (E911) call.

18. The apparatus of claim 15, wherein said emergency call setup message is received by a network element of said communication network, and wherein said network element comprises at least one of: a Call Control Element (CCE), a Border Element (BE), or an Application Server (AS).

19. The apparatus of claim 15, wherein said overload control mechanism comprises at least one of: a call gapping mechanism or a signaling message queue lengthening mechanism.

20. The apparatus of claim 19, wherein said exempting means comprises:
means for excluding said emergency call setup message from said call gapping mechanism; or
means for advancing said emergency call setup message to a head of a lengthened signaling message queue.
